(19) United States
(12) Patent Application Publication
(10) Pub. No.: US 2017/0361392 A1
(43) Pub. Date: Dec. 21, 2017

(54) MULTISTEP ELECTRODE WELD FACE GEOMETRY FOR WELD BONDING ALUMINUM TO STEEL

(71) Applicant: GM GLOBAL TECHNOLOGY OPERATIONS LLC, Detroit, MI (US)

(72) Inventors: David R. Sigler, Shelby Township, MI (US); Blair E. Carlson, Ann Arbor, MI (US); Hui-Ping Wang, Troy, MI (US); Nannan Chen, Shanghai (CN)

(21) Appl. No.: 15/616,252

(22) Filed: Jun. 7, 2017

Related U.S. Application Data
(60) Provisional application No. 62/351,110, filed on Jun. 16, 2016.

(51) Int. Cl. B23K 11/11; B23K 11/20; B23K 11/30; B23K 35/02

(52) U.S. Cl. CPC B23K 11/115; B23K 35/0205; B23K 11/20; B23K 11/3009

(57) ABSTRACT

A spot welding electrode and a method of using the electrode to resistance spot weld a workpiece stack-up that includes an aluminum workpiece and an adjacent overlapping steel workpiece are disclosed. The spot welding electrode includes a weld face having a multistep conical geometry that includes a series of steps centered on a weld face axis. The series of steps comprises an innermost first step in the form of a central plateau and, additionally, one or more annular steps that surround the central plateau and cascade radially outwardly from the central plateau towards an outer perimeter of the weld face. The weld face has a conical cross-sectional profile in which a periphery of a top plateau surface of the central plateau and a periphery of a top annular step surface of each of the one or more annular steps are contained within a conical sectional area.

### CROSS-REFERENCE TO RELATED APPLICATION(S)

This application claims the benefit of U.S. Provisional Application No. 62/351,110 filed on Jun. 16, 2016. The entire contents of the aforementioned provisional application are incorporated herein by reference in their entirety.

### TECHNICAL FIELD

The technical field of this disclosure pertains to the formation of resistance spot weld joints between an aluminum workpiece and a steel workpiece and, more specifically, to a spot welding electrode with a multistep weld face geometry that facilitates such weld bonding, particularly when an intermediate organic material is disposed between the faying surfaces of the aluminum and steel workpieces.

### Introduction

Resistance spot welding is a process used by a number of industries to join together two or more metal workpieces. The automotive industry, for example, often uses resistance spot welding to join together metal workpieces during the manufacture of structural frame members (e.g., body sides and cross members) and vehicle closure members (e.g. vehicle doors, hoods, trunk lid, and lift-gates), among others. A number of spot welds are typically formed along a peripheral edge of the metal workpieces or some other selected bonding region to ensure the part is structurally sound. While spot welding has typically been practiced to join together certain similarly-composed metal workpieces—such as steel-to-steel and aluminum-to-aluminum-the desire to incorporate lighter weight materials into the vehicle body structure has generated interest in joining a steel workpiece to an aluminum workpiece by way of resistance spot welding.

Resistance spot welding relies on the resistance to the flow of an electrical current through overlapping metal workpieces and across their faying interface(s) to generate heat. To carry out such a welding process, two opposed spot welding electrodes are clamped at diametrically aligned spots on opposite sides of the overlapping workpieces at a predetermined weld zone. The clamping force is typically in the range of about 600-1200 pounds force. An electrical current is then passed through the metal workpieces from one electrode to the other. Resistance to the flow of this electrical current generates heat within the metal workpieces and at their faying interface. When the metal workpieces being spot welded include an aluminum workpiece and an adjacently positioned steel workpiece, the heat generated within the bulk of the workpieces and at their faying interface rapidly melts the aluminum workpiece and creates a molten aluminum weld pool within the aluminum workpiece. This molten weld pool wets the adjacent surface of the steel workpiece and, upon termination of the current flow, solidifies into a weld joint that weld bonds the aluminum and steel workpieces together.

In practice, however, spot welding an aluminum workpiece to a steel workpiece is challenging since a number of characteristics of those two metals can adversely affect the strength—most notably the peel strength and the cross-tension strength—of the weld joint. Regarding the properties of the dissimilar metals, aluminum has a relatively low melting point (˜600° C.) and relatively low electrical and thermal resistivities, while steel has a relatively high melting point (˜1500° C.) and relatively high electrical and thermal resistivities. As a result of these physical differences, most of the heat is generated within the steel workpiece during current flow such that a heat imbalance exists between the steel workpiece and the aluminum workpiece. The combination of the heat imbalance created during current flow and the high thermal conductivity of the aluminum workpiece means that, immediately after the flow of electrical current is terminated, a situation occurs where heat is not disseminated symmetrically from the weld zone. Instead, heat is conducted from the hotter steel workpiece through the aluminum workpiece towards the spot welding electrode on the other side of the aluminum workpiece, which creates a steep thermal gradient in that direction.

The development of a steep thermal gradient between the steel workpiece and the spot welding electrode on the other side of the aluminum workpiece is believed to weaken the resultant weld joint in several ways. First, because the steel workpiece retains heat longer than the aluminum workpiece after the flow of electrical current is terminated, the molten aluminum weld pool created during current flow solidifies directionally, starting from the region nearest the colder spot welding electrode (often water cooled) proximate the aluminum workpiece and propagating towards the faying interface of the aluminum and steel workpieces. A solidification front of this kind tends to sweep or drive defects—such as gas porosity, shrinkage voids, and micro-cracking—towards and along the faying interface. Second, the sustained elevated temperature in the steel workpiece promotes the growth of a hard and brittle Fe—Al intermetallic layer at and along the faying interface. Having a dispersion of weld defects together with excessive growth of the Fe—Al intermetallic layer along the faying interface tends to reduce the peel and/or cross-tension strength of the weld joint.

The challenges that tend to complicate the resistance spot welding of aluminum and steel workpieces extends beyond their materially divergent properties. Each of the aluminum and steel workpieces may, in some instances, include applied or natural surface layers that differ in composition from their underlying base substrates. The aluminum workpiece, for example, may contain a surface layer comprised of a refractory oxide material. This oxide material is typically composed of aluminum oxide compounds, although other oxide compounds may also be present such as, for example, magnesium oxide compounds when the aluminum workpiece contains a magnesium-containing aluminum alloy. When composed of the refractory oxide material, the surface layer present on the aluminum workpiece is electrically insulating and mechanically tough. As a result, a residual oxide film that includes remnants of the original surface layer tends to remain intact at and alongside the faying surface of the steel workpiece where it can hinder the ability of the molten aluminum weld pool to wet the steel workpiece, which can adversely affect the strength of the joint, especially when combined with other weld joint defects that may be swept towards the faying interface due to direction solidification of the molten aluminum weld pool.

The complications attributed to the surface layer of the aluminum workpiece can be magnified when an intermediate organic material layer, such as a layer of uncured, heat-curable adhesive, is present between the faying surfaces of the aluminum and steel workpieces at the weld zone. An uncured yet heat-curable adhesive layer may be disposed between the faying surfaces of the stacked workpieces to provide additional bonding between the workpieces over a broad interfacial area around and between weld zones. In clamping the workpieces together by the forceful pressure applied by the spot welding electrodes, and prior to exchanging current, some of the adhesive is squeezed laterally out of the weld zone. The remaining adhesive is then decomposed at the location of the weld joint during current flow. Upon completion of the spot welding procedure, the adhesive-containing regions of the welded workpieces are heated, for example, in an ELPO-bake oven (ELPO refers to an electrophoretic priming operation). The applied heating cures the adhesive layer to attain strong supporting adhesion between the confronting faying surfaces of the metal workpieces around the site(s) where spot welding has been practiced.

The intermediate organic material layer has a tendency to interact with the refractory oxide material of the surface oxide layer to form a more tenacious material at spot welding temperatures. Specifically, it is believed that residues obtained from the thermal decomposition of the intermediate organic material layer—such as carbon ash, filler particles (e.g., silica, rubber, etc.), and other derivative materials—combine with the residual oxide film to form a composite residue film that is more resistant to mechanical break down and dispersion during current flow as compared to the residual oxide film alone. The formation of a tougher composite residue film results in fragments of that film remaining grouped and compiled at and along the faying surface of the steel workpiece in a much more disruptive manner as compared to instances in which an organic material layer is not present between the steel and aluminum workpieces. In that regard, it is believed that the composite residue film blocks the diffusion of iron into the molten aluminum weld pool, which can result in excessive thickening of the hard and brittle Fe—Al intermetallic layer and, thus, weaken the joint. Additionally, any gases produced during decomposition of the organic material can become trapped in the molten aluminum weld pool and may eventually lead to porosity within the solidified weld joint. Still further, the composite residue film may provide a ready crack path along the bonding interface of the weld joint and the steel workpiece which, again, can weaken the weld joint.

In light of the aforementioned challenges, previous efforts to spot weld an aluminum workpiece and a steel workpiece have employed a weld schedule that specifies higher currents, longer weld times, or both (as compared to spot welding steel-to-steel), in order to try and obtain a reasonable weld bond area. Such efforts have been largely unsuccessful in a manufacturing setting and have a tendency to damage the spot welding electrodes. Given that previous spot welding efforts have not been particularly successful, mechanical fasteners including self-piercing rivets and flow-drill screws have predominantly been used instead. Mechanical fasteners, however, take longer to put in place and have high consumable costs compared to spot welding. They also add weight to the vehicle—weight that is avoided when joining is accomplished by way of spot welding—that offsets some of the weight savings attained through the use of an aluminum workpiece in the first place. Advancements in spot welding that would make it easier to join aluminum and steel workpieces would thus be a welcome addition to the art.

### SUMMARY OF THE DISCLOSURE

A spot welding electrode according to one embodiment of the present disclosure may include a body and a weld face supported on an end of the body. The weld face has a multistep conical geometry that includes a series of steps centered on a weld face axis and contained within an outer perimeter of the weld face. The series of steps may comprise an innermost first step in the form of a central plateau and, additionally, one or more annular steps that surround the central plateau and cascade radially outwardly from the central plateau towards the outer perimeter of the weld face. The central plateau has a top plateau surface and each of the one or more annular steps has a top annular step surface. Moreover, the weld face has a conical cross-sectional profile in which a periphery of the top plateau surface of the central plateau and a periphery of the top annular step surface of each of the one or more annular steps are contained within a conical sectional area defined by an upper linear boundary line and a lower linear boundary line. The upper linear boundary line and the lower linear boundary line intersect at the periphery of the top plateau surface and extend downwardly and outwardly from a horizontal plane extending from the periphery of the top plateau surface to a horizontal plane extending from the outer perimeter of the weld face. The upper linear boundary line is inclined at an angle of 5° from the horizontal plane extending from the periphery of the top plateau surface and the lower linear boundary line is inclined at an angle of 15° from the horizontal plane extending from the periphery of the top plateau surface.

The spot welding electrode of the aforementioned embodiment may include other features or be further defined. For example, the top plateau surface of the central plateau and the periphery of the top annular step surface of each of the one or more annular steps may be aligned along a linear tangent line of constant slope that is inclined to a horizontal plane extending from the periphery of the top plateau surface by an angle that ranges from 5° to 15°. The outer perimeter of the weld face may also be aligned on the linear tangent line of constant slope along with the periphery of the top plateau surface of the central plateau and the periphery of the top annular step surface of each of the one or more annular steps. As another example, the weld face may be upwardly displaced from the end of the body by a transition nose. In yet another example, the weld face axis may be collinearly aligned with an axis of the body. And, still further, the one or more annular steps may include between two and six annular steps.

The sizes and shapes of the various features of the weld face may vary. For instance, the top plateau surface may be circular in plan view with a diameter that ranges from 2 mm to 8 mm, and a plateau side surface of the central plateau that surrounds and extends downwardly from the top plateau surface may have a height that ranges from 30 μm to 300 μm and may flare radially outwardly from the top plateau surface at an incline angle that ranges from 5° to 60°. The top plateau surface may also be either planar or convexly domed. As for the one or more annular steps, the top annular step surface of each of the one or more annular steps may have a width that ranges from 0.3 mm to 2.0 mm, and a step side surface that surrounds and extends downwardly from the top annular step surface of each of the one or more annular steps may flare radially outwardly from the top annular step surface at an incline angle that ranges from 5° to 60°. The top annular step surface of each of the one or more annular steps may also be either planar or convexly domed.

In one particular implementation of the aforementioned embodiment of the spot welding electrode, the central plateau may include a plateau side surface that extends downwardly from the top plateau surface and flares radially outwardly from the top plateau surface, and the one or more annular steps that surround the central plateau may comprise at least a first annular step contiguous with the central plateau, a second annular step contiguous with the first annular step, and a third annular step contiguous with the second annular step. The first annular step may have a first top annular step surface that extends radially outwardly from the plateau side surface of the central plateau to a first step side surface that extends downwardly from the first top annular step surface and flares radially outwardly from the first top annular step surface. Likewise, the second annular step may have a second top annular step surface that extends radially outwardly from the first step side surface of the first annular step to a second step side surface that extends downwardly from the second top annular step surface and flares radially outwardly from the second top annular step surface. And, similarly, the third annular step may have a third top annular step surface that extends radially outwardly from the second step side surface of the second annular step to a third step side surface that extends downwardly from the third top annular step surface and flares radially outwardly from the third top annular step surface.

A spot welding electrode according to another embodiment of the present disclosure may include a body and a weld face supported on an end of the body. The weld face may have a multistep conical geometry that includes a series of steps centered on a weld face axis and contained within an outer perimeter of the weld face. The series of steps may comprise an innermost first step in the form of a central plateau and, additionally, one or more annular steps that surround the central plateau and cascade radially outwardly from the central plateau towards the outer perimeter of the weld face. The central plateau has a top plateau surface and a plateau side surface that extends downwardly from the top plateau surface and flares radially outwardly from the top plateau surface, and each of the one or more annular steps has a top annular step surface and a step side surface that extends downwardly from the top annular step surface and flares radially outwardly from the top annular step surface. Moreover, the weld face has a conical cross-sectional profile in which a periphery of the top plateau surface of the central plateau and a periphery of the top annular step surface of each of the one or more annular steps are contained within a conical sectional area defined by an upper linear boundary line and a lower linear boundary line. The upper linear boundary line and the lower linear boundary line intersect at the periphery of the top plateau surface and are inclined at an angle of 5° and 15°, respectively, from a horizontal plane extending from the periphery of the top plateau surface.

The spot welding electrode of the aforementioned embodiment may include other features or be further defined. For example, the top plateau surface may circular in plan view with a diameter that ranges from 2 mm to 8 mm, and the plateau side surface may have a height that ranges from 30 μm to 300 μm and may flare radially outwardly from the top plateau surface at an incline angle that ranges from 5° to 60°. As for the one or more annular steps, the top annular step surface of each of the one or more annular steps may have a width that ranges from 0.3 mm to 2.0 mm, and the step side surface of each of the one or more annular steps may have a height that ranges from 30 μm to 300 μm and may flare radially outwardly from the top annular step surface at an incline angle that ranges from 5° to 60°. As another example, the one or more annular steps on the weld face may include between two and six annular steps.

A method of resistance spot welding a workpiece stack-up that includes an aluminum workpiece and an adjacent overlapping steel workpiece may include several steps according to one embodiment of the present disclosure. In one step, a workpiece stack-up is provided that includes an aluminum workpiece and a steel workpiece that overlaps with the aluminum workpiece to establish a faying interface between the aluminum and steel workpieces. The workpiece stack-up has an aluminum workpiece surface that provides a first side of the stack-up and a steel workpiece surface that provides an opposed second side of the stack-up. In another step, the workpiece stack-up is positioned between a weld face of a first spot welding electrode and a weld face of a second spot welding electrode. The weld face of the first spot welding electrode may comprise a series of steps that includes an innermost first step in the form of a central plateau and, additionally, one or more annular steps that surround the central plateau and cascade radially outwardly from the central plateau. The central plateau has a top plateau surface and each of the one or more annular steps has a top annular step surface. The weld face also has a conical cross-sectional profile in which a periphery of the top plateau surface of the central plateau and a periphery of the top annular step surface of each of the one or more annular steps are aligned along a linear tangent line of constant slope.

In another step, and once the workpiece stack-up is in place, the weld face of the first spot welding electrode is pressed against the first side of the workpiece stack-up such that the top plateau surface of the central plateau makes first contact with the first side of the workpiece stack-up and any pressure exerted by the weld face of the first welding electrode on the first side of the workpiece stack-up is at least initially directed through the top plateau surface of the central plateau. Also, in another step, the weld face of the second spot welding electrode is pressed against the second side of the workpiece stack-up in facial alignment with the weld face of the first spot welding electrode at a weld zone. In still a further step, an electrical current is passed between the weld face of the first spot welding electrode and the weld face of the second spot welding electrode, and through the workpiece stack-up, to grow a molten aluminum weld pool within the aluminum workpiece that wets an adjacent faying surface of the steel workpiece. The weld face of the first spot welding electrode impresses further into the first side of the workpiece stack-up during growth of the molten aluminum weld pool such that the top annular step surface of at least some of the one or more annular steps are brought into contact with the first side of the workpiece stack-up.

The method of the aforementioned embodiment may include additional steps or be further defined. For example, the workpiece stack-up may further comprise an intermediate organic material layer applied between the aluminum and steel workpieces at the faying interface. In that regard, in another step of the method, a preliminary electrical current may be passed between the weld face of the first spot welding electrode and the weld face of the second spot welding electrode, and through the workpiece stack-up, before passing the electrical current that grows the molten aluminum weld pool. The passage of the preliminary electrical current heats the intermediate organic material layer and renders it less viscous without melting the aluminum workpiece that lies adjacent to the steel workpiece. In particular, for example, if the intermediate organic material layer is a heat-curable adhesive layer, the passage of the preliminary electrical current between the weld face of the first spot welding electrode and the weld face of the second spot welding electrode may heat the heat-curable adhesive layer to between 100° C. and 150° C.

When performing the method of the aforementioned embodiment, the pressing of the weld face of the first spot welding electrode against the first side of the workpiece stack-up may drive lateral displacement of the intermediate organic material layer along the faying interface of the aluminum and steel workpieces and outside of at least a central area of the weld zone. This may occur as a result of at least initially directing any pressure exerted by the weld face of the first welding electrode on the first side of the workpiece stack-up through the top plateau surface of the central plateau at a middle of the weld zone prior to passing the electrical current between the weld face of the first welding electrode and the weld face of the second welding electrode. The method may be performed on a variety of workpiece stack-up configurations. For instance, in one implementation, the aluminum workpiece includes a faying surface and a back surface, and the steel workpiece includes a faying surface and a back surface. The faying surface of the aluminum workpiece and the faying surface of the steel workpiece may confront one another to establish the faying interface between the aluminum and steel workpieces. On the other hand, he back surface of the aluminum workpiece and the back surface of the steel workpiece may constitute the aluminum workpiece surface that provides the first side of the workpiece stack-up and the steel workpiece surface that provides the second side of the workpiece stack-up, respectively.

### BRIEF DESCRIPTION OF THE DRAWINGS

FIG. 1 is a perspective view of a spot welding electrode that includes a multistep weld face geometry according to one embodiment of the disclosure

FIG. 2 is a partial cross-sectional view of the spot welding electrode depicted in FIG. 1 according to one embodiment of the disclosure;

FIG. 3 is a magnified partial cross-sectional view of the side wall of one of the steps of the weld face depicted in FIG. 2 according to one embodiment of the disclosure;

FIG. 4 is general cross-sectional view of one embodiment of a workpiece stack-up situated between a set of opposed spot welding electrodes in preparation for resistance spot welding, wherein the workpiece stack-up includes an aluminum workpiece and an adjacent overlapping steel workpiece along with an optional intermediate organic material layer disposed between the two workpieces, and wherein each of the opposed spot welding electrodes includes a multistep weld face geometry according to one embodiment of the disclosure;

FIG. 5 is an exploded view of the workpiece stack-up and portions of the set of opposed spot welding electrodes shown in FIG. 1;

FIG. 6 is a general cross-sectional view of another embodiment of a workpiece stack-up situated between a set of opposed spot welding electrodes in preparation for resistance spot welding, wherein each of the opposed spot welding electrodes includes a multistep weld face geometry according to one embodiment of the disclosure and the workpiece stack-up includes an aluminum workpiece and an adjacent overlapping steel workpiece along with an intermediate organic material layer disposed between the two workpieces, although here the workpiece stack-up includes an additional aluminum workpiece (i.e., two aluminum workpieces and one steel workpiece);

FIG. 7 is a general cross-sectional view of another embodiment of a workpiece stack-up situated between a set of opposed spot welding electrodes in preparation for resistance spot welding, wherein each of the opposed spot welding electrodes includes a multistep weld face geometry according to one embodiment of the disclosure and the workpiece stack-up includes an aluminum workpiece and an adjacent overlapping steel workpiece along with an intermediate organic material layer disposed between the two workpieces, although here the workpiece stack-up includes an additional steel workpiece (i.e., two steel workpieces and one steel workpiece);

FIG. 8 is a general view of the workpiece stack-up (in cross-section) and the set of opposed spot welding electrodes during initial clamping of the workpiece stack-up, which may include passing a preliminary electrical current through the workpiece stack-up and between the opposed spot welding electrode at the weld zone while the welding electrodes are clamped against their respectively opposed sides of the workpiece stack-up;

FIG. 9 is a general view of the workpiece stack-up (in cross-section) and the set of opposed spot welding electrodes during passage of electrical current between the weld faces of the electrodes and through the stack-up, which occurs after the stack-up is initially clamped at the weld zone, wherein the passage of electrical current causes melting of the aluminum workpiece that lies adjacent to the steel workpiece and the creation of a molten aluminum weld pool within the aluminum workpiece;

FIG. 10 is a general view of the workpiece stack-up (in cross-section) and the set of opposed spot welding electrodes after passage of electrical current between the weld faces of the electrodes and through the stack-up has terminated, thus allowing the molten aluminum weld pool to solidify into a weld joint that weld bonds the pair of adjacent aluminum and steel workpieces together;

FIG. 11 is a general perspective view of a second spot welding electrode that may be used in conjunction with the first spot welding electrode (e.g., the spot welding electrode depicted in FIGS. 1-3) to resistance spot weld the workpiece stack-up; and

FIG. 12 is a partial cross-sectional view of the spot welding electrode depicted in FIG. 1 showing the conical sectional area that defines the conical cross-sectional weld face profile of the multistep weld face geometry of the spot welding electrode of the present disclosure.

### DETAILED DESCRIPTION

Resistance spot welding an aluminum workpiece and a steel workpiece presents some notable challenges due to the materially different properties of the dissimilar workpieces. Specifically, the refractory surface oxide layer of the aluminum workpiece is difficult to breakdown and disintegrate, which hinders the ability of the molten aluminum weld pool to wet the steel workpiece and may also contribute to near-interface defects. Moreover, the steel workpiece is more thermally and electrically resistive than the aluminum workpiece, meaning that the steel workpiece acts as a heat source and the aluminum workpiece acts as a heat conductor. The resultant heat imbalance established between the workpieces during and just after electrical current flow has a tendency to drive the weld defects, such as porosity and micro-cracks, towards and along a bonding interface of the weld joint and the steel workpiece, and also contributes to the formation and growth of a brittle Fe—Al intermetallic layer contiguous with the steel workpiece. The challenges attendant in forming a weld joint between the aluminum and steel workpieces are further complicated when an intermediate organic material layer is disposed between the faying surfaces of the overlapping workpieces.

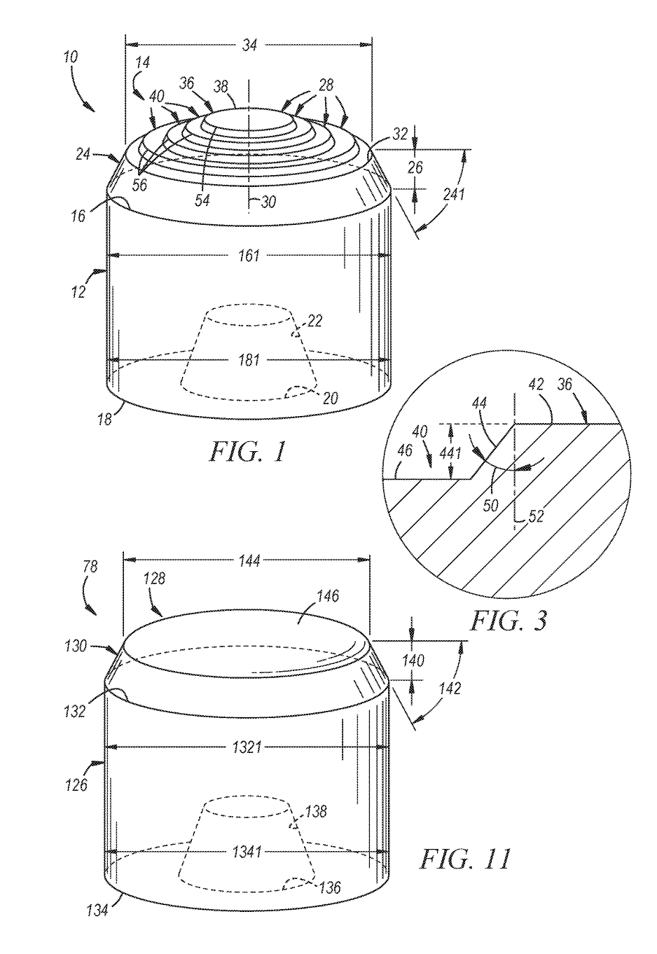

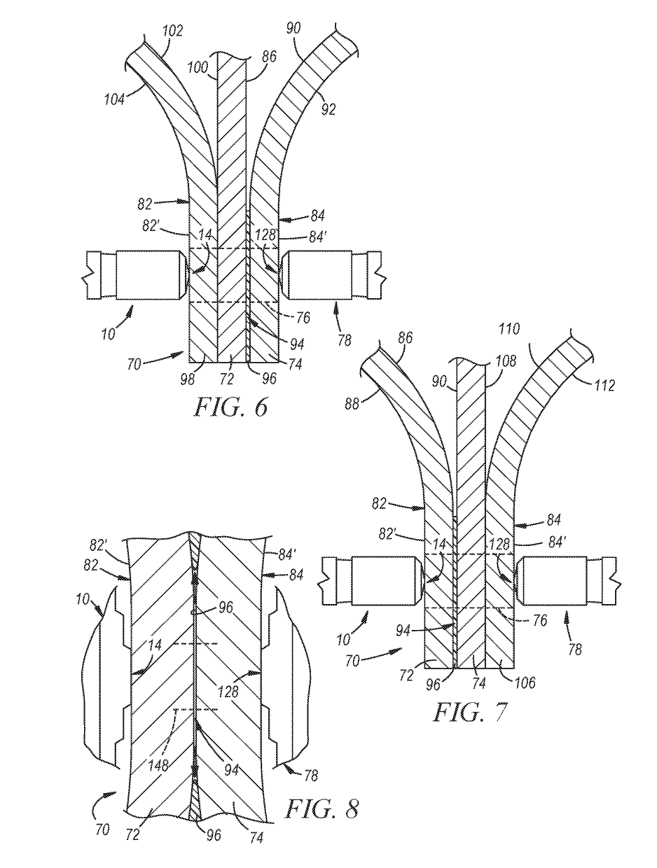

A spot welding electrode 10 that is useful in resistance spot welding applications is shown generally in FIGS. 1-3. In particular, the spot welding electrode 10 has a weld face defined by a multistep conical geometry. The spot welding electrode 10 may be used in conjunction with another spot welding electrode having a similar or dissimilar weld face geometry to spot weld a workpiece stack-up that includes at least an aluminum workpiece and an overlapping and adjacent steel workpiece, as will be described in more detail below with reference to FIGS. 4-10. For example, the spot welding electrode 10 is operable to spot weld a “2T” workpiece stack-up (FIGS. 4-5) that includes only the adjacent and overlapping pair of aluminum and steel workpieces. As another example, the spot welding electrode 10 is operable to spot weld a “3T” workpiece stack-up (FIGS. 6-7) that includes the adjacent and overlapping pair of aluminum and steel workpieces plus an additional aluminum workpiece or an additional steel workpiece so long as the two workpieces of the same base metal composition are disposed next to each other (e.g., aluminum-aluminum-steel or aluminum-steel-steel). The spot welding electrode 10 may even be used to spot weld “4T” workpiece stack-ups (e.g., aluminum-aluminum-steel-steel, aluminum-aluminum-aluminum-steel, or aluminum-steel-steel-steel).

Referring now to FIGS. 1-3, the spot welding electrode 10 includes an electrode body 12 and a weld face 14. The electrode body 12, which is preferably cylindrical in shape, has a front end 16 that presents and supports the weld face 14 and a back end 18 that facilitates mounting of the electrode 10 to a weld gun. The front end 16 of the electrode body 12 has a diameter 161 that lies within the range of 12 mm to 22 mm or, more narrowly, within the range of 16 mm to 20 mm, and the back end 18 of the electrode body 12 has a diameter 181 that is typically the same as the diameter 161 of the front end 16, particularly if the electrode body 12 is shaped as a cylindrical. Moreover, as shown generally in FIG. 1, the back end 18 of the electrode body 12 defines an opening 20 to an internal recess 22 for insertion of, and attachment with, an electrode mounting device, such as a shank adapter (not shown), that can secure the spot welding electrode 10 to a gun arm of the weld gun and also enable a flow of cooling fluid (e.g., water) through the internal recess 22 in order to manage the temperature of the electrode 10 during spot welding operations.

The weld face 14 is the portion of the spot welding electrode 10 that, during spot welding, is designed to contact a side of the workpiece stack-up under pressure and to pass electrical current through the stack-up in conjunction with the weld face of an opposed and facially aligned spot welding electrode on the opposite side of the stack-up. The weld face 14 may be upwardly displaced from the front end 16 of the electrode body 12 by a transition nose 24 or it may transition directly from the front end 16 (termed a “full face electrode”). When the transition nose 24 is present, the weld face 14 may be upwardly displaced from the front end 16 by a distance 26 that preferably lies between 2 mm to 10 mm. The transition nose 24 may be frustoconical or truncated spherical in shape, although other shapes are certainly possible. If frustoconical, the angle of truncation 241 of the nose 24 is preferably between 30° and 60° from a horizontal plane (also plane 208 as described below) at the intersection of the nose 24 and the weld face 14. If truncated spherical, the radius of curvature of the nose 24 is preferably between 6 mm and 12 mm.

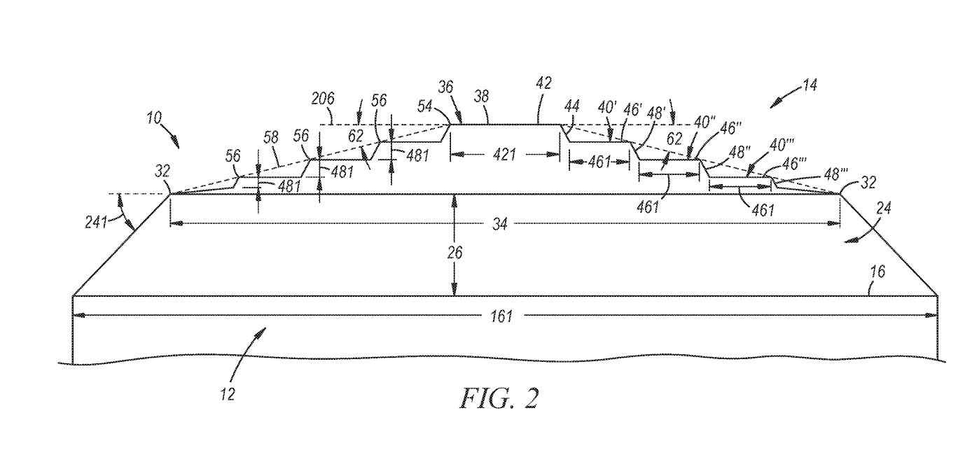

The weld face 14 has a multistep conical geometry that includes a series of steps 28 centered on a weld face axis 30 and contained within an outer perimeter 32 of the weld face 14. The weld face outer perimeter 32 has a diameter 34 that preferably ranges from 6 mm to 20 mm, or more narrowly from 8 mm to 15 mm, and it may be oriented relative to the front end 16 of the electrode body 12 in different ways. For example, as shown here in FIGS. 1-2, the outer perimeter 32 of the weld face 14 may be parallel to the front end 16 of the electrode body 12, in which case the weld face axis 30 may be parallel and collinearly aligned with an axis of the electrode body 12 or those two axes may be offset such as in the case of a double-bent welding electrode. In other embodiments, however, the outer perimeter 32 of the weld face 14 may be tilted relative to the front end 16 of the electrode body 12, in which case the weld face axis 30 and an axis of the electrode body 12 are angled with respect to one another. The latter configuration of the spot welding electrode 10 may be employed to help gain access to a weld zone of the workpiece stack-up that would otherwise be difficult to reach.

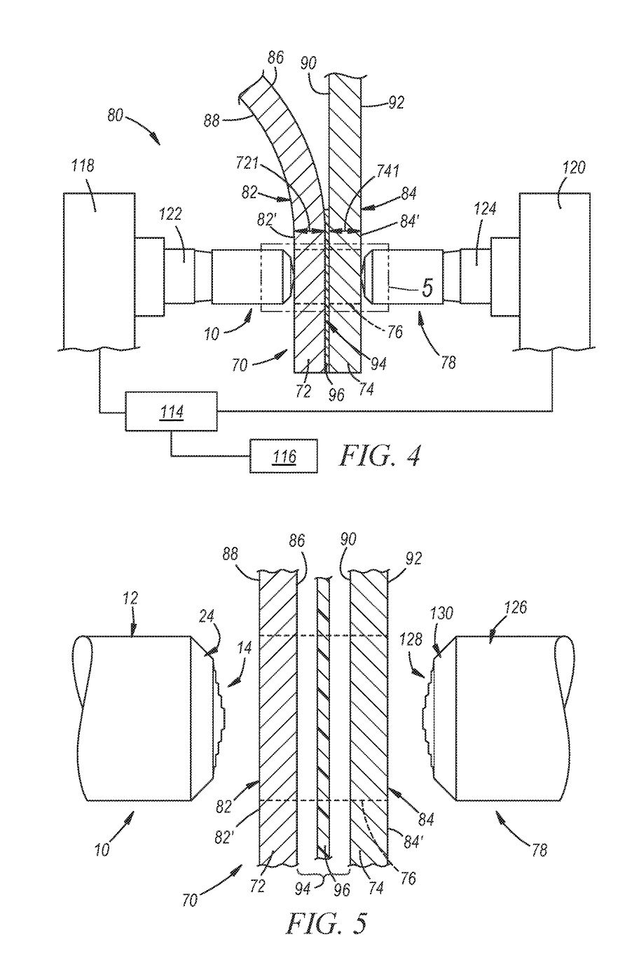

The series of steps 28 on the weld face 14 includes an innermost first step 36 in the form of a central plateau 38 and, additionally, one or more annular steps 40 that surround the central plateau 38 and cascade radially outwardly from the plateau 38 towards the outer weld face perimeter 32. The central plateau 38 includes a top plateau surface 42 and a surrounding plateau side surface 44, as shown best in FIGS. 2-3. Similarly, each of the one or more annular steps 40 includes a top annular step surface 46 and a surrounding step side surface 48. The transition between the top plateau surface 42 and the surrounding plateau side surface 44, as well as the top annular step surface 46 and the surrounding step side surface 48 of each annular step 40, is preferably a defined edge or a rounded shoulder having a radius of curvature that ranges from 30 μm to 300 μm or, more narrowly, from 50 μm to 200 μm. Anywhere from one to ten annular steps 40 may be included on the weld face 14 around the central plateau 38 with two to six annular steps 40 being preferred in many instances.

The central plateau 38 and the one or more annular steps 40 are contiguous with each other starting from the plateau side surface 44. In that regard, the top annular step surface 46 of each annular step 40 extends radially outwardly from the step side surface 48 of its radially inward neighboring annular step 40 (or the plateau side surface 44 in the case of the annular step 40 that immediately surrounds the central plateau 38). For example, in the embodiment shown here in FIGS. 1-2, the weld face 14 includes three annular steps 40 that surround the central plateau 38. Specifically, a first annular step 40′ is contiguous with the central plateau 38 of the innermost first step 36, and includes a first top annular step surface 46′ that extends radially outwardly from the plateau side surface 44 to a first step side surface 48′. Continuing on, a second annular step 40″ is contiguous with the first annular step 40′, and includes a second top annular step surface 46″ that extends radially outwardly from the first step side surface 48′ of the first annular step 40′ to a second step side surface 48″. In the same way, a third annular step 40′″ is contiguous with the second annular step 40″, and includes a third top annular step surface 46′″ that extends radially outwardly from the second step side surface 48″ of the second annular step 40″ to a third step side surface 48′″. Any additional annular steps 40 that may be present on the weld face 14 outside of the third annular step 40′″ are contiguous wither their radially inward neighboring annular step 40 in the same way.

The innermost first step 36 and the one or more surrounding annular steps 40 are sized and aligned relative to one another on the weld face 14 to help support the overall spot welding process and to obtain strong and reliable weld joints between an aluminum workpiece and an adjacent steel workpiece within the workpiece stack-up undergoing spot welding. The top plateau surface 42, for instance, may be circular in plan view and have a diameter 421 that ranges from 2 mm to 8 mm or, more narrowly, from 3 mm to 6 mm, although other profiles may be employed if desired. Moreover, in terms of its curvature, the top plateau surface 42 may be planar or it may be convexly domed. If convexly domes, the top plateau surface 42 may, for example, be spherically domed with a radius of curvature that preferably ranges from 15 mm to 300 mm or, more narrowly, from 20 mm to 200 mm. When afforded with these size and curvature dimensions, the top plateau surface 42 is able to initially concentrate and direct the pressure exerted through the spot welding electrode 10 onto a more limited area of the workpiece stack-up in order to laterally displace and substantially clear organic material such as, for example, uncured structural adhesive, if such organic material is present, from at least a central area of the weld zone, as will be described in more detail below.

The plateau side surface 44 that surrounds and extends downwardly from the top plateau surface 42 has a height 441 that preferably ranges from 30 μm to 300 μm or, more narrowly, from 50 μm to 250 μm, as shown in FIG. 3. This height dimension 441—also referred to as a step size of the central plateau 38—is measured as the distance between the closest points of the top plateau surface 42 and the top annular step surface 46 of the immediately surrounding annular step 40 (e.g., the top annular step surface 46′ of the second annular step 40′) parallel to the weld face axis 30. And, to promote retractability of the weld face 14 from engaged workpiece stack-up surfaces, the plateau side surface 44 may flare radially outwardly as it extends from the top plateau surface 42 to the top annular step surface 46 of the immediately surrounding annular step 40, as shown best in FIG. 3. The extent of the incline of the plateau side surface 44 can be measured by an incline angle 50, which is the angle at which the plateau side surface 44 deviates from a line 52 that runs parallel to the weld face axis 30 and intersects the top plateau surface 42 at the outer perimeter 32 of the weld face 14. In a preferred embodiment, the incline angle 50 of the plateau side surface 44 ranges from 5° to 60° or, more narrowly, from 20° to 50°.

Referring now specifically to FIGS. 1-2, the top annular step surface 46 of each annular step 40 is displaced axially below (along the weld face axis 30) the top annular step surface 46 of its radially inward neighboring annular step 40 or, in the case of the annular step 40 that immediately surrounds the central plateau 38, the top plateau surface 42. The top annular step surface 46 of each of the annular steps 40 has a width 461 that extends from the step side surface 48 of its radially inward neighboring annular step 40 (or the plateau side surface 44 in the case of the annular step 40 that immediately surrounds the central plateau 38) to its own step side surface 48 that extends downwardly from the top annular step surface 46. The width 461 of each of the top annular step surfaces 46 preferably ranges from 0.3 mm to 2.0 mm or, more narrowly, from 0.5 mm to 1.5 mm. And, in terms of curvature, the top annular step surface 46 of each annular step 40 may be planar or it may have a spherical radius of curvature that preferably ranges from 50 mm to 300 mm or, more narrowly, from 75 mm to 200 mm.

The step side surface 48 of each of the annular steps 40 is fashioned similarly to the plateau side surface 44 of the central plateau 38. Each of the step side surfaces 48, for instance, has a height 481 measured in the same way as the plateau side surface 44 (i.e., the distance between the closest points of the relevant top annular step surfaces 46 parallel to the weld face axis 30) that preferably ranges from 30 μm to 300 μm or, more narrowly, from 50 μm to 250 μm. Additionally, each of the step side surfaces 48 may flare radially outwardly as it extends from the top annular step surface 46 of its respective annular step 40 to the top annular surface 46 of the next immediately surrounding and axially downward displaced annular step 40. The extent of the incline of the step side surface(s) 48 can be measured by the same incline angle 50 that is shown in FIG. 3 and described above in the context of the plateau side surface 44. The previous discussion of the incline angle 40 thus applies equally to each of the step side surfaces 48 of the annular steps 40 and the fact that FIG. 3 demonstrates the incline angle 50 in the context of the plateau side surface 44 does not make a difference. In a preferred embodiment, the incline angle 50 of each of the step side surfaces 48 ranges from 5° to 60° or, more narrowly, from 20° to 50°.

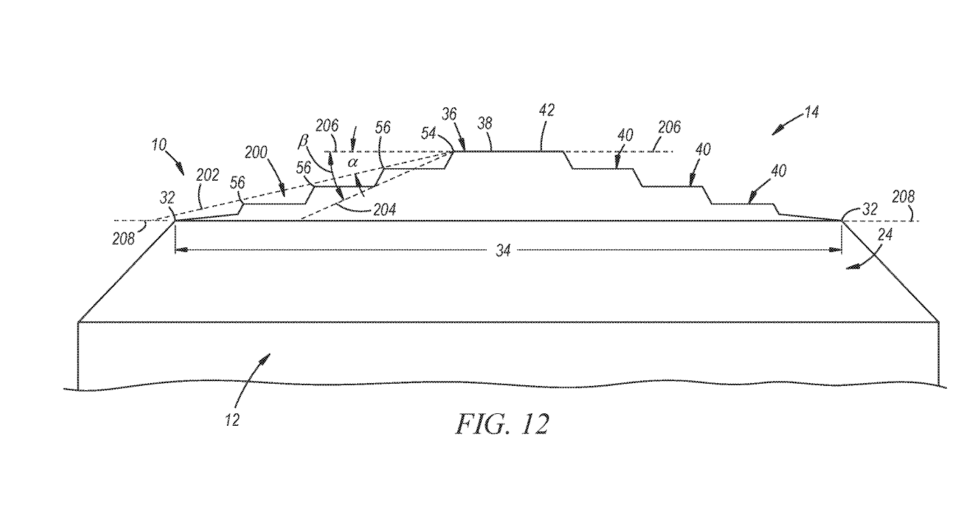

A notable geometric characteristic of the spot welding electrode 10 is the cross-sectional profile of the weld face 14, as depicted best in FIG. 12. Indeed, the central plateau 38 and the one or more surrounding annular steps 40 are arranged to provide the weld face 14 with a conical cross-sectional weld face profile to help support the initial pressure concentration through the central plateau, followed by the application of radial outward pressure forces as the one or more annular steps 40 are brought into contact one-by-one with the workpiece stack-up, and to also contain the growing molten aluminum weld pool. The conical cross-sectional weld face profile is established when a periphery 54 of the top plateau surface 42 and a periphery 56 of the top annular step surface 46 of each of the one or more annular steps 40 are contained within a conical sectional area 200 defined by an upper linear boundary line 202 and a lower linear boundary line 204. The upper linear boundary line 202 and the lower linear boundary line intersect at the periphery 54 of the top plateau surface 42 and extend downwardly and outwardly from a horizontal plane 206 extending through and from the periphery 54 of the top plateau surface 42 to a horizontal plane 208 extending through and from the outer perimeter 32 of the weld face 14. The upper linear boundary line 202 is inclined at an angle α from the horizontal plane 206 extending from the periphery 54 of the top plateau surface 42 and the lower linear boundary line 204 is inclined at an angle θ from the same horizontal plane 60. The angle of inclination of the upper linear boundary line 202 (angle α) is 5° and the angle of inclination of the lower linear boundary line 204 (angle β) is 15°. Alternatively, if a tighter conical sectional area 200 is desired, these angles α, β are 7° and 12°, respectively.

The periphery 54 of the top plateau surface 42 and the periphery 56 of the top annular step surface 46 of each of the one or more annular steps 40 may be aligned within the conical section area 200 or they not. For example, in one particular embodiment, and as shown in FIG. 2, the periphery 54 of the top plateau surface 42 and the periphery 56 of the top annular step surface 46 of each of the one or more annular steps 40 is aligned along a linear tangent line 58 of constant slope; that is, the outermost radial portions of the top plateau surface 42 and the top annular step surface(s) 46 are intersected by the linear tangent line 58 within, of course, acceptable manufacturing tolerances of ±0.1 mm. The tangent line 58 that establishes the conical cross-sectional weld face profile may be inclined to the horizontal plane 206 extending from the periphery 54 of the top plateau surface 42 by an angle 62 that preferably ranges from 5° to 15° or, more narrowly, from 7° to 12°. Accordingly, the linear tangent line 58 may be collinear with the upper linear boundary line 202, collinear with the lower linear boundary line 204, or lie somewhere between the upper linear boundary line 202 and the lower linear boundary line 204. Moreover, in some instances, and as shown here in FIG. 2, the tangent line 58 may also intersect the outer perimeter 32 of the weld face 14.

At least the weld face 14 of the spot welding electrode 10, and preferably the entire spot welding electrode 10 including the electrode body 12, the weld face 14, and the transition nose 24 if present, is constructed from a material having an electrical conductivity of at least 45% IACS and a thermal conductivity of at least 180 W/mK. Some material classes that fit these criteria include a copper alloy, a dispersion-strengthened copper material, and a refractory-based material that includes at least 35 wt %, and preferably at least 50 wt %, of a refractory metal. Specific examples of suitable copper alloys include a C15000 copper-zirconium (CuZr) alloy, a C18200 copper-chromium (CuCr) alloy, and a C18150 copper-chromium-zirconium (CuCrZr) alloy. A specific example of a dispersion-strengthened copper material includes copper with a dispersal of aluminum oxide. And a specific example of a refractory-base material includes a tungsten-copper metal composite that contains between 50 wt % and 90 wt % of a tungsten particulate phase dispersed in copper matrix that constitutes the balance (between 50 wt % and 10 wt %) of the composite. Other materials not expressly listed here that meet the applicable electrical and thermal conductivity standards may, of course, also be used as well.

Referring now to FIGS. 4-10, the spot welding electrode 10 may be used to resistance spot weld a workpiece stack-up 70 that comprises at least an aluminum workpiece 72 and a steel workpiece 74 that overlap and lie adjacent to one another at a weld zone 76. Indeed, as will be described in greater detail below, the disclosed spot welding method is broadly applicable to a wide variety of workpiece stack-up configurations that include the adjacent pair of aluminum and steel workpieces 72, 74. The workpiece stack-up 70 may, for example, include only the aluminum workpiece 72 and the steel workpiece 74 as far as the number of workpieces are concerned, or it may include an additional aluminum workpiece (aluminum-aluminum-steel) or an additional steel workpiece (aluminum-steel-steel) so long as the two workpieces of the same base metal composition are disposed next to each other in the stack-up 70. The workpiece stack-up 70 may even include more than three workpieces such as an aluminum-aluminum-steel-steel stack-up, an aluminum-aluminum-aluminum-steel stack-up, or an aluminum-steel-steel-steel stack-up. The aluminum and steel workpieces 72, 74 may be worked or deformed before or after being assembled into the workpiece stack-up 70 depending on the part being manufactured and the specifics of the overall manufacturing process.

The workpiece stack-up 70 is illustrated in FIG. 4 along with the spot welding electrode 10 described above (hereafter referred to as the “first spot welding electrode” for purposes of identification) and a second spot welding electrode 78 that are mechanically and electrically configured on a weld gun 80 (partially shown). The workpiece stack-up 70 has a first side 82 provided by an aluminum workpiece surface 82′ and a second side 84 provided by a steel workpiece surface 84′. The two sides 82, 84 of the workpiece stack-up 70 are accessible to the set of first and second spot welding electrodes 10, 78, respectively, at the weld zone 76; that is, the first spot welding electrode 10 is arranged to make contact with and be pressed against the first side 82 of the workpiece stack-up 70 while the second spot welding electrode 78 is arranged to make contact with and be pressed against the second side 84. And while only one weld zone 76 is depicted in the figures, skilled artisans will appreciate that spot welding may be practiced according to the disclosed method at multiple different weld zones 76 within the same stack-up 70.

The aluminum workpiece 72 includes an aluminum substrate that is either coated or uncoated. The aluminum substrate may be composed of unalloyed aluminum or an aluminum alloy that includes at least 85 wt % aluminum. Some notable aluminum alloys that may constitute the coated or uncoated aluminum substrate are an aluminum-magnesium alloy, an aluminum-silicon alloy, an aluminum-magnesium-silicon alloy, and an aluminum-zinc alloy. If coated, the aluminum substrate may include a surface layer comprised of a refractory oxide material such as a native oxide coating that forms naturally when the aluminum substrate is exposed to air and/or an oxide layer created during exposure of the aluminum substrate to elevated temperatures during manufacture, e.g., a mill scale. The refractory oxide material is typically comprised of aluminum oxide compounds and possibly other oxide compounds as well, such as magnesium oxide compounds if, for example, the aluminum substrate is an aluminum-magnesium alloy. The aluminum substrate may also be coated with a layer of zinc, tin, or a metal oxide conversion coating comprised of oxides of titanium, zirconium, chromium, or silicon, as described in US Pat. Pub. No. 2014/0360986. The surface layer may have a thickness ranging from 1 nm to 10 μm depending on its composition and may be present on each side of the aluminum substrate. Taking into account the thickness of the aluminum substrate and any surface layer that may be present, the aluminum workpiece 72 has a thickness 721 that ranges from 0.3 mm to about 6.0 mm, or more narrowly from 0.5 mm to 3.0 mm, at least at the weld site 76.

The aluminum substrate of the aluminum workpiece 72 may be provided in wrought or cast form. For example, the aluminum substrate may be composed of a 4xxx, 5xxx, 6xxx, or 7xxx series wrought aluminum alloy sheet layer, extrusion, forging, or other worked article. Alternatively, the aluminum substrate may be composed of a 4xx.x, 5xx.x, 6xx.x, or 7xx.x series aluminum alloy casting. Some more specific kinds of aluminum alloys that may constitute the aluminum substrate include, but are not limited to, AA5754 and AA5182 aluminum-magnesium alloy, AA6111 and AA6022 aluminum-magnesium-silicon alloy, AA7003 and AA7055 aluminum-zinc alloy, and A1-10Si-Mg aluminum die casting alloy. The aluminum substrate may further be employed in a variety of tempers including annealed (O), strain hardened (H), and solution heat treated (T), if desired. The term “aluminum workpiece” as used herein thus encompasses unalloyed aluminum and a wide variety of aluminum alloys, whether coated or uncoated, in different spot-weldable forms including wrought sheet layers, extrusions, forgings, etc., as well as castings.

The steel workpiece 74 includes a steel substrate from any of a wide variety of strengths and grades that is either coated or uncoated. The steel substrate may be hot-rolled or cold-rolled and may be composed of steel such as mild steel, interstitial-free steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel workpiece 74 includes press-hardened steel (PHS). Preferred compositions of the steel substrate, however, include mild steel, dual phase steel, and boron steel used in the manufacture of press-hardened steel. Those three types of steel have ultimate tensile strengths that, respectively, range from 150 MPa to 500 MPa, from 500 MPa to 1100 MPa, and from 1200 MPa to 1800 MPa.

The steel workpiece 74 may include a surface layer on one side or both sides of the steel substrate. If coated, the steel substrate preferably includes a surface layer of zinc (e.g., hot-dip galvanized), a zinc-iron alloy (e.g., galvanneal or electrodeposited), a zinc-nickel alloy (e.g., electrodeposited), nickel, aluminum, an aluminum-magnesium alloy, an aluminum-zinc alloy, or an aluminum-silicon alloy, any of which may have a thickness of up to 50 μm on each side of the steel substrate. Taking into account the thickness of the steel substrate and any surface layer that may be present, the steel workpiece 74 has a thickness 741 that ranges from 0.3 mm and 6.0 mm, or more narrowly from 0.6 mm to 2.5 mm, at least at the weld site 76. The term “steel workpiece” as used herein thus encompasses a wide variety of steel substrates, whether coated or uncoated, of different grades and strengths.

When the two workpieces 72, 74 are stacked-up for spot welding in the context of a “2T” stack-up embodiment, which is illustrated in FIGS. 4-5, the aluminum workpiece 72 and the steel workpiece 74 present the first and second sides 82, 84 of the workpiece stack-up 70, respectively. In particular, the aluminum workpiece 72 includes a faying surface 86 and a back surface 88 and, likewise, the steel workpiece 74 includes a faying surface 90 and a back surface 92. The faying surfaces 86, 90 of the two workpieces 72, 74 overlap and confront one another to establish a faying interface 94 that extends through the weld zone 76 and which may optionally encompass an intermediate organic material layer 96 applied between the faying surfaces 86, 90. The back surfaces 88, 92 of the aluminum and steel workpieces 72, 74, on the other hand, face away from one another in opposite directions at the weld zone 76 and constitute, respectively, the aluminum workpiece surface 82′ and the steel workpiece surface 84′ of the first and second sides 82, 84 of the workpiece stack-up 70.

The intermediate organic material layer 96 that may be present between the faying surfaces 86, 90 of the aluminum and steel workpieces 72, 74 may be an adhesive layer that includes a structural thermosetting adhesive matrix. The structural thermosetting adhesive matrix may be any curable structural adhesive including, for example, as a heat-curable epoxy or a heat-curable polyurethane. Some specific examples of heat-curable structural adhesives that may be used as the thermosetting adhesive matrix include DOW Betamate 1486, Henkel Terokal 5089, and Uniseal 2343, all of which are commercially available. Additionally, the adhesive layer may further include optional filler particles, such as silica particles, dispersed throughout the thermosetting adhesive matrix to modify the viscosity or other mechanical properties of the adhesive layer for manufacturing operations. In addition to an adhesive layer, the intervening organic material layer 96 may include other organic material layers such as a sound-proofing layer or an organic sealer, to name but a few other possibilities.

The intermediate organic material layer 96, if present, can be spot welded through at the temperatures and electrode clamping pressures attained at the weld zone 76 during current flow between the spot welding electrodes 10, 78. Under spot welding conditions, the intermediate organic material layer 96 is laterally displaced with the help of the multistep conical geometry of the first spot welding electrode 10 such that very little, if any, organic material is thermally decomposed within the weld zone 76 during current flow so that only minimal, if any, residual materials (e.g., carbon ash, filler particles, etc.) are produced near the faying surface 90 of the steel workpiece 74. Outside of the weld zone 76, however, the intermediate organic material layer 96 remains generally undisturbed. Thus, in the case of an adhesive layer, the undisturbed adhesive outside of the weld zone 76 is able to provide additional bonding between the faying surfaces 86, 90 of the aluminum and steel workpieces 72, 74. To achieve such additional bonding, the workpiece stack-up 70 may be heated in an ELPO-bake oven or other heating apparatus following spot welding to cure the structural thermosetting adhesive matrix of the adhesive layer that is still intact outside of and around the weld zone(s) 76.

The term “faying interface 94” is thus used broadly in the present disclosure and is intended to encompass any overlapping and confronting relationship between the faying surfaces 86, 90 of the workpieces 72, 74 in which resistance spot welding can be practiced. The faying surfaces 86, 90 may, for example, be in direct contact with each other such that they physically abut and are not separated by a discrete intervening material layer (i.e., the intervening organic material layer 96 is not present). As another example, the faying surfaces 86, 90 may be in indirect contact with each other such as when they are separated by the intervening organic material layer 96—and thus do not experience the type of interfacial physical abutment found in direct contact—yet are in close enough proximity to each other that resistance spot welding can still be practiced. This type of indirect contact between the faying surfaces 86, 90 of the aluminum and steel workpieces 72, 74 typically results when the intermediate organic material layer 96 is applied between the faying surfaces 86, 90 to a thickness at least within the weld zone 76 that ranges from 0.1 mm to 2.0 mm or, more narrowly, from 0.2 mm to 1.0 mm.

Of course, as shown in FIGS. 6-7, the workpiece stack-up 70 is not limited to the inclusion of only the aluminum workpiece 72 and the adjacent steel workpiece 74 as far as the number of workpieces are concerned. The workpiece stack-up 70 may also include at least an additional aluminum workpiece or an additional steel workpiece—in addition to the adjacent aluminum and steel workpieces 72, 74—so long as the additional workpiece is disposed adjacent to the workpiece 72, 74 of the same base metal composition; that is, any additional aluminum workpiece is disposed adjacent to the aluminum workpiece 72 opposite the faying interface 94 and any additional steel workpiece is disposed adjacent to the steel workpiece 74 opposite the faying interface 94. As for the characteristics of the additional workpiece(s), the descriptions of the aluminum workpiece 72 and the steel workpiece 74 provided above are applicable to any additional aluminum or any additional steel workpiece that may be included in the workpiece stack-up 70. It should be noted, though, that while the same general descriptions apply, there is no requirement that the additional aluminum workpiece(s) and/or the additional steel workpiece(s) be identical in terms of composition, thickness, or form (e.g., wrought or cast) to the aluminum workpiece 72 and the steel workpiece 74, respectively, that lie next to each other within the workpiece stack-up 70.

As shown in FIG. 6, for example, the workpiece stack-up 70 may include the adjacent aluminum and steel workpieces 72, 74 described above along with an additional aluminum workpiece 98. Here, as shown, the additional aluminum workpiece 98 overlaps the adjacent aluminum and steel workpieces 72, 74 and lies next to the aluminum workpiece 72. When the additional aluminum workpiece 98 is so positioned, the back surface 92 of the steel workpiece 74 constitutes the steel workpiece surface 84′ that provides the second side 84 of the workpiece stack-up 70, as before, while the aluminum workpiece 72 that lies adjacent to the steel workpiece 74 now includes a pair of opposed faying surfaces 86, 100. The faying surface 86 of the aluminum workpiece 72 that faces the faying surface 90 of the steel workpiece 74 continues to establish the faying interface 94 between the two workpieces 72, 74 as previously described. The other faying surface 100 of the aluminum workpiece 72 overlaps and confronts a faying surface 102 of the additional aluminum workpiece 98. As such, in this particular arrangement of lapped workpieces 98, 72, 74, a back surface 104 of the additional aluminum workpiece 98 now constitutes the aluminum workpiece surface 82′ that provides the first side 82 of the workpiece stack-up 70.

In another example, as shown in FIG. 7, the workpiece stack-up 70 may include the adjacent aluminum and steel workpieces 72, 74 described above along with an additional steel workpiece 106. Here, as shown, the additional steel workpiece 106 overlaps the adjacent aluminum and steel workpieces 72, 74 and lies next to the steel workpiece 74. When the additional steel workpiece 106 is so positioned, the back surface 88 of the aluminum workpiece 72 constitutes the aluminum workpiece surface 82′ that provides the first side 82 of the workpiece stack-up 70, as before, while the steel workpiece 74 that lies adjacent to the aluminum workpiece 72 now includes a pair of opposed faying surfaces 90, 108. The faying surface 90 of the steel workpiece 74 that faces the faying surface 86 of the aluminum workpiece 72 continues to establish the faying interface 94 between the two workpieces 72, 74 as previously described. The other faying surface 108 of the steel workpiece 74 overlaps and confronts a faying surface 110 of the additional steel workpiece 106. As such, in this particular arrangement of lapped workpieces 72, 74, 106, a back surface 112 of the additional steel workpiece 106 now constitutes the steel workpiece surface 84′ that provides the second side 84 of the workpiece stack-up 70.

Returning now to FIG. 4, the first spot welding electrode 10 and the second spot welding electrode 78 are used to pass electrical current through the workpiece stack-up 70 and across the faying interface 94 of the adjacent aluminum and steel workpieces 72, 74 at the weld zone 76 regardless of whether an additional aluminum and/or steel workpiece is present. Each of the spot welding electrodes 10, 78 is carried by the weld gun 80, which may be of any suitable type including a C-type or an X-type weld gun. The spot welding operation may call for the weld gun 80 to be mounted to a robot capable of moving the weld gun 80 around the workpiece stack-up 70 as needed, or it may call for the weld gun 80 to be configured as a stationary pedestal-type in which the workpiece stack-up 70 is manipulated and moved relative to the weld gun 80. Additionally, as illustrated schematically here, the weld gun 80 may be associated with a power supply 114 that delivers electrical current between the spot welding electrodes 10, 78 according to a programmed weld schedule administered by a weld controller 116. The weld gun 80 may also be fitted with coolant lines and associated control equipment in order to deliver a coolant fluid, such as water, to each of the spot welding electrodes 10, 78.

The weld gun 80 includes a first gun arm 118 and a second gun arm 120. The first gun arm 118 is fitted with a shank 122 that secures and retains the first spot welding electrode 10 and the second gun arm 120 is fitted with a shank 124 that secures and retains the second spot welding electrode 78. The secured retention of the spot welding electrodes 10, 78 on their respective shanks 122, 124 can be accomplished by way of shank adapters that are located at axial free ends of the shanks 122, 124. In terms of their positioning relative to the workpiece stack-up 70, the first spot welding electrode 10 is positioned for contact with the first side 82 of the stack-up 70, and, consequently, the second spot welding electrode 78 is positioned for contact with the second side 84 of the stack-up 70. The first and second weld gun arms 118, 120 are operable to converge or pinch the spot welding electrodes 10, 78 towards each other and to impose a clamping force on the workpiece stack-up 70 at the weld zone 76 once the electrodes 10, 78 are brought into contact with their respective workpiece stack-up sides 82, 84.

The second spot welding electrode 78 employed opposite the first spot welding electrode 10 can be any of a wide variety of electrode designs. In general, and referring now to FIGS. 4-5, the second spot welding electrode 78 includes an electrode body 126, a weld face 128, and optionally a transition nose 130 that serves to upwardly displace the weld face 128 from a front end 132 of the electrode body 126. The weld face 128 is the portion of the second spot welding electrode 78 that makes contact with the second side 84 of the workpiece stack-up 70 opposite the weld face 14 of the first spot welding electrode 10 during spot welding. At least the weld face 128 of the second spot welding electrode 78, and preferably the entire spot welding electrode 78 including the electrode body 126, the weld face 128, and the transition nose 130 if present, is constructed from a material having an electrical conductivity of at least 70% IACS, or more preferably at least 90% IACS, and a thermal conductivity of at least 300 W/mK. Some materials that meet these criteria include a C15000 copper-zirconium (CuZr) alloy, a C18200 copper-chromium (CuCr) alloy, and a C18150 copper-chromium-zirconium (CuCrZr) alloy, and a dispersion-strengthened copper material such as copper with an aluminum oxide dispersion. Other materials not expressly listed here that meet the applicable electrical and thermal conductivity standards may, of course, also be used as well.

In a preferred embodiment, the second spot welding electrode 78 is constructed similarly to the first spot welding electrode 10 and, accordingly, the description above regarding the first spot welding electrode 10 and the contents of FIGS. 1-3 are equally applicable here. In other words, the structure of the electrode body 126, the weld face 128, and the optional transition nose 130 of the second spot welding electrode 78 has the same structural features and is consistent with the discussion above regarding the structure of the electrode body 12, the weld face 14, and the optional transition nose 24 of the first spot welding electrode 10. And while the second spot welding electrode 78 can have a similar structure to the first spot welding electrode 10, the first and second spot welding electrodes 10, 78 do not necessarily have to be identical and indistinguishable in every facet. To be sure, the first and second spot welding electrodes 10, 78 can share a similar structure, especially if they both employ a multistep conical weld face geometry, while still exhibiting some structural distinctions that fall within the permitted numerical variances detailed herein.

In an alternative embodiment, and referring now to FIG. 11, the second spot welding electrode 78 may be constructed differently from the first spot welding electrode 10, most notably in the geometry of its weld face 128. In particular, the electrode body 126 of the second spot welding electrode 78, which is preferably cylindrical in shape, has the front end 132 that presents and supports the weld face 128 and a back end 134 that facilitates mounting of the electrode 78 to the weld gun 80. The front end 132 of the electrode body 126 has a diameter 1321 that lies within the range of 12 mm to 22 mm or, more narrowly, within the range of 16 mm to 20 mm, and the back end 134 of the electrode body 126 has a diameter 1341 that is typically the same as the diameter 1321 of the front end 132, particularly if the electrode body 126 is shaped as a cylindrical. Moreover, the back end 134 of the electrode body 126 defines an opening 136 to an internal recess 138 for insertion of, and attachment with, an electrode mounting device, such as a shank adapter (not shown), that can secure the spot welding electrode 78 to the second gun arm 120 of the weld gun 80 and also enable a flow of cooling fluid (e.g., water) through the internal recess 138 in order to manage the temperature of the electrode 78 during spot welding operations.

The weld face 128 may be upwardly displaced from the front end 132 of the electrode body 126 by the transition nose 130 or it may transition directly from the front end 132 (a “full face electrode”). When the transition nose 130 is present, the weld face 128 may be upwardly displaced from the front end 132 by a distance 140 that preferably lies between 2 mm to 10 mm. The transition nose 130 may be frustoconical or truncated spherical in shape, although other shapes are certainly possible. If frustoconical, an angle of truncation 142 of the nose 130 is preferably between 15° and 40° from a horizontal plane at the intersection of the nose 130 and the weld face 128. If truncated spherical, the radius of curvature of the nose 130 is preferably between 6 mm and 12 mm.

A broad range of electrode weld face designs may be implemented for the second spot welding electrode 78. The weld face 128, for example, may have a diameter 144 that ranges from 3 mm to 16 mm or, more narrowly, from 4 mm to 8 mm, and may include a base weld face surface 146 that is either planar or convexly domed. If convexly domed, the base weld face surface 146 ascends upwardly and inwardly from its outer perimeter. In one embodiment, for example, the base weld face surface 146 may be spherically domed and have a radius of curvature that ranges from 15 mm to 400 mm or, more narrowly, from 25 mm to 100 mm. Moreover, the base weld face surface 146 may be smooth, roughened, or may include a series of upstanding concentric rings of circular ridges such as the ridges disclosed in U.S. Pat. Nos. 8,222,560; 8,436,269; 8,927,894; or in U.S. Pat. Pub. No. 2013/0200048. Several specific examples of additional weld face designs that may be employed on the second spot welding electrode 78 are a weld face having a smooth, 25-mm radius spherically domed base weld face surface 146 or a 25-mm radius spherically domed base weld face surface 146 with anywhere from three to eight concentric circular rings of ridges that project outwardly from the base weld face surface 146. The ridges may have heights in the range of 20 μm to 400 μm and have blunted cross-sectional profiles while being radially spaced apart (midpoint to midpoint of adjacent ridges) on the base weld face surface 146 by a distance that ranges from 50 μm to 1800 μm.

The power supply 114 that delivers electrical current for passage between the first and second spot welding electrodes 10, 78 during spot welding of the workpiece stack-up 70 is preferably a medium-frequency direct current (MFDC) inverter power supply that electrically communicates with the spot welding electrodes 10, 78. A MFDC power supply generally includes an inverter and a MFDC transformer. Such a transformer is commercially available from a number of suppliers including ARO Welding Technologies (US headquarters in Chesterfield Township, Mich.), RoMan Manufacturing Incorporated (US headquarters in Grand Rapids, Mich.) and Bosch Rexroth (US headquarters in Charlotte, N.C.). The MFDC inverter power supply is configured to pass direct current (DC) between the spot welding electrodes 10, 78 at current levels up to 50 kW. Other types of power supplies may certainly be used to conduct the disclosed method despite not being expressly identified here.

The power supply 114 is controlled by the weld controller 116 in accordance with programmed weld schedule tailored to carry out spot welding of the workpiece stack-up 10. The weld controller 116 interfaces with the power supply 114 and allows a user or operator to set the waveform of the electrical current being passed between the spot welding electrodes 10, 78 in order to initiate and grow a molten aluminum weld pool that ultimately solidifies into a weld joint that weld bonds the aluminum and steel workpieces 72, 74 together at the weld zone 76. Indeed, the weld controller 116 allows for customized control of the current level at any given time and the duration of current flow at any given current level, among others, and further allows for such attributes of the electrical current to be responsive to changes in very small time increments down to fractions of a millisecond.

The resistance spot welding method will now be described with reference to FIGS. 4 and 8-10, which depict only the aluminum and steel workpieces 72, 74 that overlap and lie adjacent to one another so as to establish the faying interface 94. The presence of additional workpieces in the workpiece stack-up 70 including, for example, the additional aluminum or steel workpieces 98, 106 described above, does not affect how the spot welding method is carried out or have any substantial effect on the joining mechanism that takes place at the faying interface 94 of the adjacent aluminum and steel workpieces 72, 74. The more-detailed discussion provided below thus applies equally to instances in which the workpiece stack-up 70 is a “3T” stack-up that includes the additional aluminum workpiece 98 (FIG. 6) or the additional steel workpiece 106 (FIG. 7), as well as “4T” stack-ups, despite the fact that those additional workpieces are not illustrated in FIGS. 4 and 8-10.

The disclosed method involves first assembling, if needed, the workpiece stack-up 70 including the pair of adjacent aluminum and steel workpieces 72, 74 together with the optional intermediate organic material layer 96 that extends through the weld zone 76 over a broader joining region. Once assembled, the workpiece stack-up 70 is positioned between the first spot welding electrode 10 and the opposed second spot welding electrode 78. The weld face 14 of the first spot welding electrode 10 is positioned to contact the aluminum workpiece surface 82′ of the first side 82 of the workpiece stack-up 70 and the weld face 128 of the second spot welding electrode 78 is positioned to contact the steel workpiece surface 84′ of the second side 84 of the stack-up 70. The weld gun 80 is then operated to converge the first and second spot welding electrodes 10, 78 relative to one another so that their respective weld faces 14, 128 are pressed against the opposite first and second sides 82, 84 of the stack-up 70 at the weld zone 76. The weld faces 14, 128 are typically facially aligned with each other at the weld zone 76 under a clamping force imposed on the workpiece stack-up 70 that ranges from 400 lb (pounds force) to 2000 lb or, more narrowly, from 600 lb to 1300 lb.

As a function of the multistep conical geometry of the weld face 14 of the first spot welding electrode 10, the pressure exerted by the first spot welding electrode 10 is initially concentrated and directed through the top plateau surface 42 of the central plateau 38 onto a corresponding limited area of the first side 82 of the workpiece stack-up 70, as illustrated in FIG. 8. The focused direction of the clamping pressure through a limited area stresses and distorts the faying surfaces 86, 90 of the aluminum and steel workpieces 72, 74 together at the middle of the weld zone 76 and, furthermore, drives lateral displacement of the intermediate organic material layer 96, if present, along the faying interface 94 and outside of at least a central area 148 of the weld zone 76. Such lateral displacement of the intermediate organic material layer 96 (if present) substantially clears the organic material from at least the central area 148, which may be between 2 mm and 4 mm in diameter, leaving behind only minimal organic material of less than 0.1 mm in thickness, if any.

In those instances in which the intermediate organic material layer 96 is present between the faying surfaces 86, 90 of the aluminum and steel workpieces 72, 74, a preliminary electrical current ranging between 3 kA rms and 15 kA rms over the preheating time period may be passed between the first and second spot welding electrodes 10, 78 and through the workpiece stack-up 10 while pressing the welding electrodes 10, 78 against the opposite sides 82, 84 of the stack-up 70. Passage of the preliminary electrical current heats the faying interface 94, and thus the intermediate organic material layer 96, without melting the aluminum workpiece 72. Such preheating renders the intermediate organic material layer 96 less viscous and more compliant without curing or thermally decomposing the layer 96. While preheating of the intermediate organic material layer 96 during passage of the preliminary electrical current is subject to some variance, a preferred temperature that achieves good flowability, particularly if the layer 96 contains a structural thermosetting adhesive matrix, is between 100° C. and 150° C. or, more narrowly, between 120° C. and 140° C. The preheating of the intermediate organic material layer 96 with the preliminary electrical current, in conjunction with initially directing the pressure exerted by the first spot welding electrode 10 through the central plateau 38, may laterally displace and substantially clear the intermediate organic material layer 96 over a larger area than using only the clamping pressure of the spot welding electrodes 10, 78.

After the spot welding electrodes 10, 78 are pressed against their respective sides 82, 84 of the workpiece stack-up 10, and the optional passage of the preliminary electrical current has been carried out, an electrical current is passed between the facially-aligned weld faces 14, 128 of the first and second spot welding electrodes 10, 78 to form a weld joint 150 (FIG. 10). The exchanged electrical current may be constant or pulsed over time, or some combination of the two, and typically has a current level that ranges from 5 kA and 50 kA and lasts for a total duration of 40 ms to 4,000 ms. As a few specific examples, the schedule of the applied electrical current may be in the nature of the multi-step schedules disclosed in US2015/0053655 and US2017/0106466, the entire contents of each of those applications being incorporated herein by reference, or another weld schedule that is suitable for the workpiece stack-up 70.

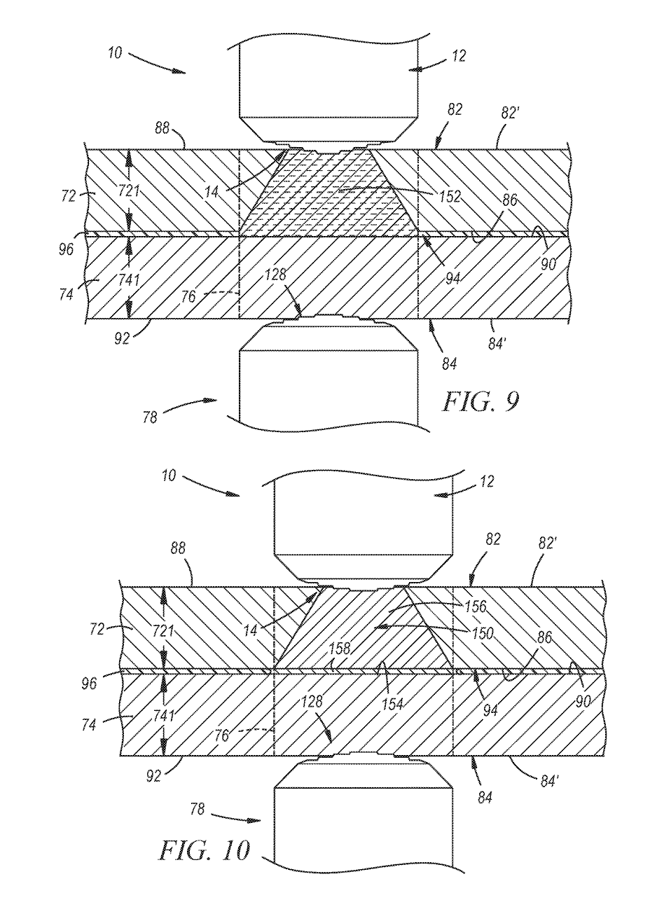

Referring now to FIG. 9, the electrical current flowing between the first and second spot welding electrodes 10, 78 heats the more electrically- and thermally-resistive steel workpiece 74 quite rapidly. This heat is transferred to the aluminum workpiece 72 and causes the aluminum workpiece 72 to begin to melt within the weld zone 76. The melting of the aluminum workpiece 72 creates a molten aluminum weld pool 152. The molten aluminum weld pool 152 wets the adjacent faying surface 90 of the steel workpiece 74. And since only a minimal amount, if any, of the intermediate organic material layer 96 remains within the central area 148 of the weld zone 76 when electrical current flow is commenced, if the intermediate organic material layer 96 was originally applied in the first place, the interactions that would transpire between the residual oxide film (if present) and the thermal decomposition residues from the organic material layer 96 are not nearly as prevalent as they would otherwise be when using conventional spot welding practices. The avoidance of such interactions and the resulting formation of a tougher, more tenacious composite residue film helps maintain the wettability of the faying surface 90 of the steel workpiece 74.

During the time the molten aluminum weld pool 152 is growing within the aluminum workpiece 72 to is final size, the weld face 14 of the first spot welding electrode 10 impresses further into the first side 82 of the workpiece stack-up 70, which successively brings the one or more annular steps 40 into pressed contact with the first side 82. The pressure exerted on the first side 82 of the workpiece stack-up 10 by each additional annular step 40 that is brought to bear against with the first side 82 may contribute to further laterally displacement the intermediate organic material layer 96 beyond that which was previously achieved prior to electrical current flow and melting of the aluminum workpiece 72. In addition to laterally displacing the intermediate organic material layer 96, the continued impression or indentation of the weld face 14 into the aluminum workpiece 72 causes the molten aluminum weld pool 152 to flow laterally and increase in diameter along the faying surface 90 of the steel workpiece 74. This effect is enhanced at the center of the molten aluminum weld pool 152 by the central plateau 38, which extends further into the weld pool 152 than any other portion of the weld face 14. The multistep conical geometry of the weld face 14 thus has the added function of enticing lateral movement of the molten aluminum weld pool 152 and, consequently, sweeping residual oxide film and/or composite residue film that may be present, if any, away from the interface of the molten aluminum weld pool 152 and the faying surface 90 of the steel workpiece 74 and outside of the weld zone 76.

The continued impression of the weld face 14 of the first spot welding electrode 10 eventually contains the molten aluminum weld pool 152 within the outer weld face diameter 32. The molten aluminum weld pool 152 may have a diameter along the faying surface of the steel workpiece 74 that ranges from 3 mm to 15 mm, or more narrowly from 6 mm to 10 mm, and may penetrate a distance into the aluminum workpiece 72 that ranges from 20% to 100% of the thickness 721 of the aluminum workpiece 72 at the weld site 76. And, in terms of its composition, the molten aluminum weld pool 152 is composed predominantly of aluminum material derived from the aluminum workpiece 72. The passage of the electrical current between the weld faces 14, 128 of the first and second spot welding electrodes 10, 78 is eventually terminated, thereby allowing the molten aluminum weld pool 152 to solidify into the weld joint 150 as depicted in FIG. 10. The weld joint 150 is the material that weld bonds the adjacent aluminum and steel workpieces 72, 74 together. In particular, the weld joint 150 establishes a bonding interface 154 with the faying surface 90 of the steel workpiece 74 and includes two main components: (1) an aluminum weld nugget 156 and (2) a Fe—Al intermetallic layer 158. In general, the bonding interface 154 of the formed weld joint 150 and the steel workpiece 74 is expected to be largely free of contaminating material derived from the thermal decomposition of the intermediate organic material layer 96 if such a layer is originally present between the aluminum and steel workpieces 72, 74. And, if desired, portions of the weld joint 150 may be re-melted and re-solidified numerous times for the reasons provided in US2017/0106466.

The aluminum weld nugget 156 is comprised of resolidified aluminum and extends into the aluminum workpiece 72 to a distance that ranges from 20% to 100% of the thickness 721 of the aluminum workpiece 72 at the weld zone 76. The Fe—Al intermetallic layer 158 is situated between the aluminum weld nugget 156 and the faying surface 90 of the steel workpiece 74 and is contiguous with the bonding interface 154. The Fe—Al intermetallic layer 158 is produced due to a reaction between the molten aluminum weld pool 152 and iron that diffuses from the steel workpiece 74 at spot welding temperatures, and typically comprises FeAl₃ compounds, Fe₂Al₅ compounds, and possibly other Fe—Al intermetallic compounds as well. The Fe—Al intermetallic layer 158 is harder and more brittle than the aluminum weld nugget 156 and often has an average thickness of 1 μm to 7 μm along the bonding interface 154 of the weld joint 150 and the steel workpiece 74.

The Fe—Al intermetallic layer 158 is less liable to compromise the strength and mechanical properties of the weld joint 150 after performing the disclosed spot welding method. Indeed, the removal of the intermediate organic material layer 96, if originally present, from within the weld zone 76 as aided by the multistep conical geometry of the weld face 14 of the first welding electrode 10 effectively minimizes or altogether eliminates the thermal decomposition residues from the layer 96 that can lead to near-interface defects within the brittle Fe—Al intermetallic layer 158. Moreover, in the event that some quantity of thermal decomposition residues derived from the intermediate organic material layer 96 remain within the weld zone 76 and are exposed to the molten aluminum weld pool 152, lateral flow of the molten aluminum weld pool 152 as induced by the multistep conical weld face geometry of the first spot welding electrode 12 can sweeps those residues away from the weld zone 76 and the bonding interface 154 to further improve the mechanical performance of the solidified weld joint 150. In that regard, the wide-spread distribution of weld joint disparities that has been found to frequently occur in conventional spot welding practices when an intermediate organic material is present is, at the very least, not as prevalent when spot welding is conducted according to the presently disclosed method.

After the disclosed spot welding method is completed, and the weld joint 150 is formed so as to weld bond the aluminum and steel workpieces 72, 74 together, the clamping force imposed on the workpiece stack-up 70 at the weld zone 76 is relieved and the first and second spot welding electrodes 10, 78 are retracted away from their respective workpiece sides 82, 84. The workpiece stack-up 70 may now be moved relative to the weld gun 80 so that the first and second spot welding electrodes 10, 78 are positioned in facing alignment at another weld zone 76 where the disclosed method is repeated. Once the desired number of resistance spot weld joints 150 has been formed on the workpiece stack-up 70, which typically ranges anywhere from 1 to 50, the stack-up 70 may be subject to further processing if appropriate. For example, if an uncured yet heat-curable adhesive layer is applied between the aluminum and steel workpieces 72, 74 prior to spot welding, the workpiece stack-up 70 may be heated to cure the heat-curable adhesive layer that remains intact outside of the weld zone 76 of each weld joint 150, but within the adhesive coated joining region(s) of the stack-up 70, to attain additional adherent adhesive bonding between the faying surfaces 86, 90 of the aluminum and steel workpieces 72, 74. The requisite heating of the workpiece stack-up 70 may be performed in an ELPO-bake oven, furnace, or other heating apparatus.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A spot welding electrode comprising:
a body;
a weld face supported on an end of the body, the weld face having a multistep conical geometry that includes a series of steps centered on a weld face axis and contained within an outer perimeter of the weld face, the series of steps comprising an innermost first step in the form of a central plateau and, additionally, one or more annular steps that surround the central plateau and cascade radially outwardly from the central plateau towards the outer perimeter of the weld face, the central plateau having a top plateau surface and each of the one or more annular steps having a top annular step surface, wherein the weld face has a conical cross-sectional profile in which a periphery of the top plateau surface of the central plateau and a periphery of the top annular step surface of each of the one or more annular steps are contained within a conical sectional area defined by an upper linear boundary line and a lower linear boundary line that intersect at the periphery of the top plateau surface and extend downwardly and outwardly from a horizontal plane extending from the periphery of the top plateau surface to a horizontal plane extending from the outer perimeter of the weld face, and wherein the upper linear boundary line is inclined at an angle of 5° from the horizontal plane extending from the periphery of the top plateau surface and the lower linear boundary line is inclined at an angle of 15° from the horizontal plane extending from the periphery of the top plateau surface.

2. The spot welding electrode set forth in claim 1, wherein the top plateau surface of the central plateau and the periphery of the top annular step surface of each of the one or more annular steps are aligned along a linear tangent line of constant slope that is inclined to the horizontal plane extending from the periphery of the top plateau surface by an angle that ranges from 5° to 15°.

3. The spot welding electrode set forth in claim 2, wherein the outer perimeter of the weld face is also aligned on the linear tangent line of constant slope along with the periphery of the top plateau surface of the central plateau and the periphery of the top annular step surface of each of the one or more annular steps.

4. The spot welding electrode set forth in claim 1, wherein the weld face is upwardly displaced from the end of the body by a transition nose.

5. The spot welding electrode set forth in claim 1, wherein the weld face axis is collinearly aligned with an axis of the body.

6. The spot welding electrode set forth in claim 1, wherein the one or more annular steps includes between two and six annular steps.

7. The spot welding electrode set forth in claim 1, wherein the top plateau surface is circular in plan view with a diameter that ranges from 2 mm to 8 mm, and wherein a plateau side surface of the central plateau that surrounds and extends downwardly from the top plateau surface has a height that ranges from 30 μm to 300 μm and flares radially outwardly from the top plateau surface at an incline angle that ranges from 5° to 60°.

8. The spot welding electrode set forth in claim 7, wherein top plateau surface is either planar or convexly domed.

9. The spot welding electrode set forth in claim 1, wherein the top annular step surface of each of the one or more annular steps has a width that ranges from 0.3 mm to 2.0 mm, and wherein a step side surface that surrounds and extends downwardly from the top annular step surface of each of the one or more annular steps flares radially outwardly from the top annular step surface at an incline angle that ranges from 5° to 60°.

10. The spot welding electrode set forth in claim 9, wherein the top annular step surface of each of the one or more annular steps is either planar or convexly domed.

11. The spot welding electrode set forth in claim 1, wherein the central plateau includes a plateau side surface that extends downwardly from the top plateau surface and flares radially outwardly from the top plateau surface, and wherein the one or more annular steps that surround the central plateau comprise at least a first annular step contiguous with the central plateau, a second annular step contiguous with the first annular step, and a third annular step contiguous with the second annular step, the first annular step having a first top annular step surface that extends radially outwardly from the plateau side surface of the central plateau to a first step side surface that extends downwardly from the first top annular step surface and flares radially outwardly from the first top annular step surface, the second annular step having a second top annular step surface that extends radially outwardly from the first step side surface of the first annular step to a second step side surface that extends downwardly from the second top annular step surface and flares radially outwardly from the second top annular step surface, and the third annular step having a third top annular step surface that extends radially outwardly from the second step side surface of the second annular step to a third step side surface that extends downwardly from the third top annular step surface and flares radially outwardly from the third top annular step surface.

12. A spot welding electrode comprising:
a body;
a weld face supported on an end of the body, the weld face having a multistep conical geometry that includes a series of steps centered on a weld face axis and contained within an outer perimeter of the weld face, the series of steps comprising an innermost first step in the form of a central plateau and, additionally, one or more annular steps that surround the central plateau and cascade radially outwardly from the central plateau towards the outer perimeter of the weld face, the central plateau having a top plateau surface and a plateau side surface that extends downwardly from the top plateau surface and flares radially outwardly from the top plateau surface, and each of the one or more annular steps having a top annular step surface and a step side surface that extends downwardly from the top annular step surface and flares radially outwardly from the top annular step surface, and wherein the weld face has a conical cross-sectional profile in which a periphery of the top plateau surface of the central plateau and a periphery of the top annular step surface of each of the one or more annular steps are aligned along a linear tangent line of constant slope that is inclined to a horizontal plane extending from the periphery of the top plateau surface by an angle that ranges from 5° to 15°.

13. The spot welding electrode set forth in claim 12, wherein the top plateau surface is circular in plan view with a diameter that ranges from 2 mm to 8 mm, wherein the plateau side surface has a height that ranges from 30 μm to 300 μm and flares radially outwardly from the top plateau surface at an incline angle that ranges from 5° to 60°, wherein the top annular step surface of each of the one or more annular steps has a width that ranges from 0.3 mm to 2.0 mm, and wherein the step side surface of each of the one or more annular steps has a height that ranges from 30 μm to 300 μm and flares radially outwardly from the top annular step surface at an incline angle that ranges from 5° to 60°.

14. The spot welding electrode set forth in claim 12, wherein the one or more annular steps includes between two and six annular steps.

15. A method of resistance spot welding a workpiece stack-up that includes an aluminum workpiece and an adjacent overlapping steel workpiece, the method comprising:
providing a workpiece stack-up that includes an aluminum workpiece and a steel workpiece that overlaps with the aluminum workpiece to establish a faying interface between the aluminum and steel workpieces, the workpiece stack-up having an aluminum workpiece surface that provides a first side of the stack-up and a steel workpiece surface that provides an opposed second side of the stack-up;
positioning the workpiece stack-up between a weld face of a first spot welding electrode and a weld face of a second spot welding electrode, the weld face of the first spot welding electrode comprising a series of steps that includes an innermost first step in the form of a central plateau and, additionally, one or more annular steps that surround the central plateau and cascade radially outwardly from the central plateau, the central plateau having a top plateau surface and each of the one or more annular steps having a top annular step surface, wherein the weld face has a conical cross-sectional profile in which a periphery of the top plateau surface of the central plateau and a periphery of the top annular step surface of each of the one or more annular steps are contained within a conical sectional area defined by an upper linear boundary line and a lower linear boundary line that intersect at the periphery of the top plateau surface and are inclined at an angle of 5° and 15°, respectively, from a horizontal plane extending from the periphery of the top plateau surface;
pressing the weld face of the first spot welding electrode against the first side of the workpiece stack-up such that the top plateau surface of the central plateau makes first contact with the first side of the workpiece stack-up and any pressure exerted by the weld face of the first welding electrode on the first side of the workpiece stack-up is at least initially directed through the top plateau surface of the central plateau;
pressing the weld face of the second spot welding electrode against the second side of the workpiece stack-up in facial alignment with the weld face of the first spot welding electrode at a weld zone;
passing an electrical current between the weld face of the first spot welding electrode and the weld face of the second spot welding electrode, and through the workpiece stack-up, to grow a molten aluminum weld pool within the aluminum workpiece that wets an adjacent faying surface of the steel workpiece, wherein the weld face of the first spot welding electrode impresses further into the first side of the workpiece stack-up during growth of the molten aluminum weld pool such that the top annular step surface of at least some of the one or more annular steps are brought into contact with the first side of the workpiece stack-up.

16. The method set forth in claim 15, wherein the workpiece stack-up further comprises an intermediate organic material layer applied between the aluminum and steel workpieces at the faying interface.

17. The method set forth in claim 16, further comprising passing a preliminary electrical current between the weld face of the first spot welding electrode and the weld face of the second spot welding electrode, and through the workpiece stack-up, before passing the electrical current that grows the molten aluminum weld pool, wherein passing the preliminary electrical current heats the intermediate organic material layer and renders it less viscous without melting the aluminum workpiece that lies adjacent to the steel workpiece.

18. The method set forth in claim 17, wherein the intermediate organic material layer is a heat-curable adhesive layer, and wherein passing the preliminary electrical current between the weld face of the first spot welding electrode and the weld face of the second spot welding electrode heats the heat-curable adhesive layer to between 100° C. and 150° C.

19. The method set forth in claim 16, wherein pressing the weld face of the first spot welding electrode against the first side of the workpiece stack-up drives lateral displacement of the intermediate organic material layer along the faying interface of the aluminum and steel workpieces and outside of at least a central area of the weld zone as a result of at least initially directing any pressure exerted by the weld face of the first welding electrode on the first side of the workpiece stack-up through the top plateau surface of the central plateau at a middle of the weld zone prior to passing the electrical current between the weld face of the first welding electrode and the weld face of the second welding electrode.

20. The method set forth in claim 15, wherein the aluminum workpiece includes a faying surface and a back surface, and the steel workpiece includes a faying surface and a back surface, the faying surface of the aluminum workpiece and the faying surface of the steel workpiece confronting one another to establish the faying interface between the aluminum and steel workpieces, and the back surface of the aluminum workpiece and the back surface of the steel workpiece constituting the aluminum workpiece surface that provides the first side of the workpiece stack-up and the steel workpiece surface that provides the second side of the workpiece stack-up, respectively.
